(19) United States
(12) Patent Application Publication
(10) Pub. No.: US 2011/0314043 A1
(43) Pub. Date: Dec. 22, 2011

(54) FULL-FIDELITY REPRESENTATION OF XML-REPRESENTED OBJECTS

(75) Inventors: Philip A. Bernstein, Bellevue, WA (US); Sergey Melnik, Kirkland, WA (US); James F. Terwilliger, Redmond, WA (US); Ion Vasillian, Seattle, WA (US)

(73) Assignee: Microsoft Corporation, Redmond, WA (US)

(21) Appl. No.: 12/817,372

(22) Filed: Jun. 17, 2010

(51) Int. Cl. G06F 17/00; G06F 17/30

(52) U.S. Cl. 707/769; 715/234; 707/E17.014; 707/E17.005

(57) ABSTRACT

A data structure may exist in various representations, such as an object in an object-oriented system or a set of elements included in an extensible markup language (XML) document structured according to an XML type defined in an XML schema. While many aspects of these representations may correspond, some aspects of an XML document may not be specified by the XML schema (such as developer comments, whitespace, and preprocessor directives), and may be lost while translating an XML representation of the data structure to an object. These non-schematized aspects may be included in the object as a delta, specifying the location of an aspect with relation to an element defined by the XML schema. Preserving non-schematized aspects may promote the full representation of the data structure as an object, and may facilitate a full-fidelity regeneration of the XML document from which the object was generated.

### BACKGROUND

Within the field of computing, many scenarios involve the generation and use of a data structure comprising one or more fields, which may have an identifier (such as a name) and may be assigned a value, a collection of values such as an array, or an encapsulation of other data structures. The data structure may be represented in many ways. As a first example, the data structure may be represented as an object in an object-oriented system, and in particular as an instance of a class that defines a set of members (including member functions, member variables, and member references to other objects). As a second example, the data structure may be represented as an element of a particular type in an extensible markup language (XML) document, where the type of the element (corresponding to the structure of the data structure) is defined by the XML schema of the XML document, and where the fields of the data structure are specified as nested elements within the element, as attributes of various elements, and/or as data stored within an element. As a third example, the data structure may be represented in a relation of a relational database, where the relation comprises a set of well-formatted attributes (thereby defining the structure of the data structure) and a set of records having values for respective attributes. This representation is often visualized as a table having a set of columns (representing attributes) with well-defined formats, and a set of rows (representing instances of the data structure) having values in different columns.

Each representation of the data structure may have particular advantages, and an application may endeavor to utilize a particular representation of the data. Moreover, an application may be configured to utilize different representations of the data structure in different circumstances (e.g., an object representation may be useful for interacting with the data structure; an XML representation may be useful for transmitting the data structure to another device in a serialized manner; and a database representation may be useful for facilitating storage and persistence of the data structure). Therefore, an application may be configured to convert a first representation of the data structure to a second representation (e.g., by serializing an object into an XML fragment for transmission over a network, and/or by materializing an object from a record of a relational database).

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Because the different representations of a data structure are based on similar concepts (such as encapsulation, collections, polymorphism, and formatting) but have different behaviors, many aspects of a data structure existing in a first representation may be translated into a second representation. However, the expressive powers are not identical, and particular aspects of a first representation may not be represented in a second representation. In particular, while a significant portion of an XML document formatted according to an XML schema may be automatically translated into an object that can be accessed via members of the object class, some aspects of the XML document may not be representable in the object. For example, some portions of the XML document may comprise non-schematized items that are not defined by the XML schema, such as comments, whitespace, XML preprocessing directives, and elements and attributes that are included in the XML document but that are not defined by the XML schema. Although this information is not included in the XML schema, some of this information may be of significant value to developers; e.g., comments included in the XML document, although undefined by the XML schema, may explain the operation or semantics of the data structure to a developer; and some elements and attributes may not be defined by the XML schema. In many conventional parsing techniques, if the class of an object is defined according to an XML schema, it may be difficult to store extra information comprising the non-schematized elements. In addition to representing a loss of potentially valuable information, this divergence may render unachievable a regeneration of the source XML document in a manner that reconstructs the XML document with full fidelity with the original XML document.

Presented herein are techniques for generating various representations of a data structure that promote the fidelity of the data structure across translations into different representations. In particular, when a data structure is represented in an XML document, the data structure may be translated into an object of a class that also includes the non-schematized information of the XML document; and when the data structure is represented as an object of a class, it may be translated into an XML document that includes all of the non-schematized information in an original XML document from which the object was initially generated. These techniques involve parsing an XML document according an XML schema and, for the schematized elements of a data structure stored therein, extracting such elements as members of an object having a class defined according to the schema, and also adding to the object a delta, comprising the non-schematized information in the XML document. The information in the delta may indicate both the content of the information and the location of the information in relation to the schematized elements and attributes of the XML document. An application that utilizes the object may therefore utilize all of the information in the XML document by referencing both the members of the object and the information stored in the delta. Additionally, the object may be rendered back to a data structure formatted according to the XML schema by referring to both the members of the object and the information in the delta, thereby generating an XML document having full fidelity with the original XML document from which the object was derived. Additional variations presented herein relate to the efficient translation of the data structure; to the processing of updates to the members of an object such that the updates are reflected in a corresponding XML document; and to the representation of the non-schematized information in the delta of an object.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring various representations of a data structure as an object, in an XML document, and in a relational database.

FIG. 2 is an illustration of an exemplary scenario featuring a full-fidelity translation of a data structure in an XML document to an object according to the techniques presented herein.

FIG. 3 is a flow chart illustrating an exemplary method of presenting a data structure formatted as an XML type and stored in an XML document formatted according to a schema.

FIG. 4 is a component block diagram illustrating an exemplary system for presenting a data structure formatted as an XML type and stored in an XML document formatted according to a schema.

FIG. 5 is an illustration of an exemplary computer-readable medium comprising processor-executable instructions configured to embody one or more of the provisions set forth herein.

FIG. 6 is an illustration of an exemplary scenario featuring a translation of an XML document to an object based using an object builder utilizing a set of mappings generated from an XML schema according to which the XML document is formatted.

FIG. 7 is an illustration of an exemplary scenario featuring the generation of a delta having a set of anchors representing non-schematized aspects of an XML document.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The respective fields may comprise a name or other identifier of the field and an associated value, which may comprise a simple data type (e.g., an integer, a floating-point number, a character, a string, or a Boolean value), a collection of simple data types (e.g., an n-dimensional array or a hashtable), or one or more other data structures that may be included via encapsulation (e.g., a second data structure is wholly included as a subset of a first data structure) or referencing (e.g., the second data structure exists outside of the first data structure, but the first data structure includes a reference, such as a memory address or uniform resource identifier (URI), to the location of the second data structure).

Within these scenarios, a data structure may be represented in many ways. As a first example, the data structure may be represented as an object in an object-oriented system, where the data structure is instantiated in memory as an instance of a class. The class defines the structure of any instances, such as the names, types, and relationships of various members (e.g., functions, variables, and references to other objects), and a particular object, as an instance of the class, is structured according to the definition of the class and contains particular values for respective members.

As a second example, the data structure may be represented in a declarative document that is specified in an extensible markup language (XML). This type of document comprises a hierarchically nested set of elements denoted in a “tag” format, such as by enclosing the data comprising the element in angle brackets, and formatting each tag as “self-closing” (comprising a single tag with no nested elements) or as having an opening tag and a closing tag (which may include one or more nested elements). Respective elements may also specify one or more attributes within a tag, e.g., as a set of name/value pairs. A data structure may be represented in an XML document by specifying respective fields within the data structure as an element, with values associated with the element specified either as an attribute of the tag, as a value included between the opening tag and the closing tag of the element for the data structure, or as one or more nested tags representing other data structures that are encapsulated in or referenced by the parent data structure.

As a third example, the object may be stored in a relational database comprising a set of relations having various attributes defined by particular attribute criteria and a set of records having a value for the respective attributes (e.g., a table having a set of columns representing the fields of the data structure of the class, and a set of rows respectively representing a data structure and specifying values in each column associated with a field of the data structure). While these relations are often two-dimensional and atomic (e.g., a record often cannot specify one or more encapsulated records for a particular attribute), relational databases permit a record to store in an attribute a reference to a second record (which may be stored within another table or the same table), thereby simulating encapsulation of a second data structure within a first data structure.

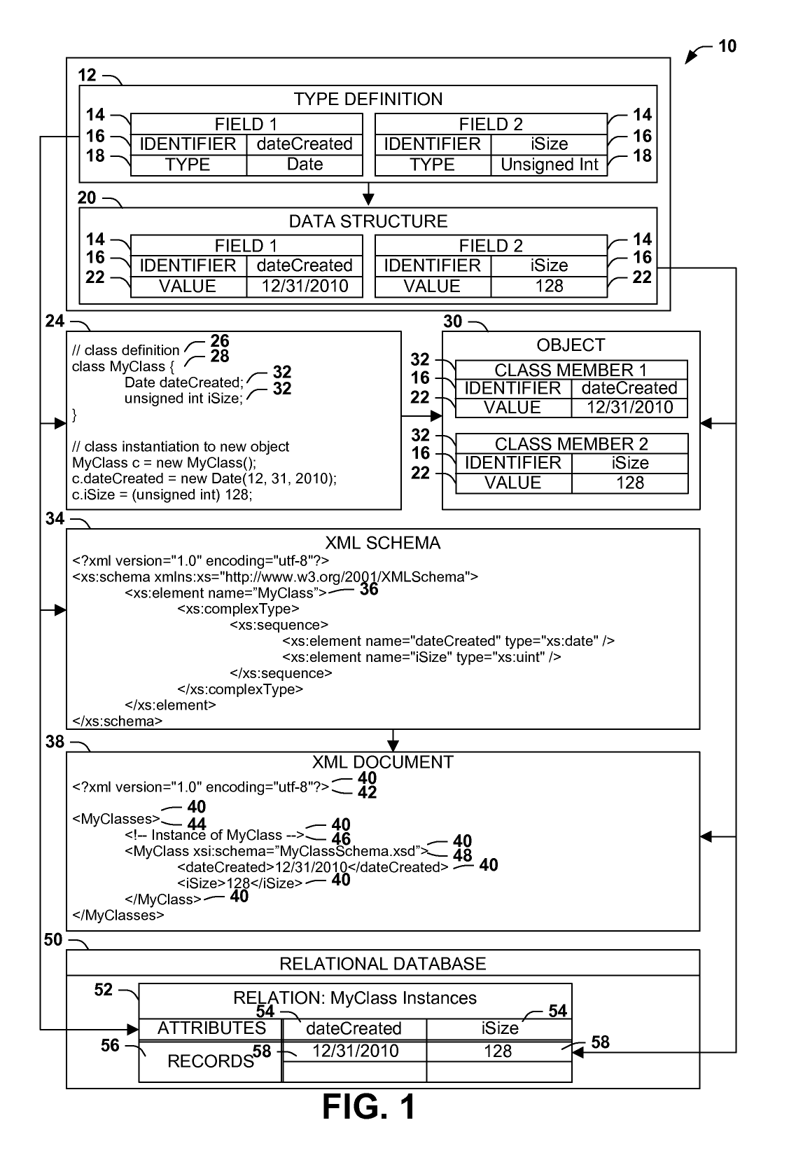

FIG. 1 presents an exemplary scenario 10 featuring various representations of a data structure 20 formatted according to a type definition 12. The type definition 12 may identify several fields 14, each having an identifier 16, such as a name or a distinctive number, and a type 18, such as a primitive type (e.g., an integer, a floating-point number, a character, a string, or a Boolean value), a complex type (e.g., another data structure 20 that is embedded in or referenced by the type definition 12), or a collection (e.g., an array, list, or hashtable of various other data structures 20).The data structure 20 may be formatted according to the type definition 12, e.g., featuring a first field 14 and a second field 14 respectively having the identifiers 16 specified in the type definition 12, and storing values 22 formatted according to the respective types 18 specified in the type definition 12. In this exemplary scenario 10, the type definition 12 specifies a first field 14 having the identifier “dateCreated” and of the “Date” type 18, and a second field 14 having the identifier “iSize” and of the “Unsigned Int” type 18. The data structure 20 based upon this type definition 12 also includes these fields 14, formatted according to the types 18 in the type definition 12, but features values 22 thereof comprising, respectively, the date “12/31/2010” and the number “128.”

Based on this type definition 12, several representations are possible. A first representation is illustrated in a code block 24 featuring a class definition 26 that specifies the details of a class 28 named “MyClass,” featuring class members 32 corresponding to the fields 14 of the type definition 12 (and also specifying identifiers 16 and types 18 thereof). The code block 24 also illustrates an instantiation of the class 28 as an object 30, which has various class members 32 as specified in the class definition 26 of the class 28, such as a first class member 32 having the identifier “dateCreated” and a second class member 32 having the identifier “iSize,” and having values 22 corresponding to those in the data structure 20. The object 30 comprises an in-memory representation of the data structure 20, and may be designed and structured according to various object-oriented programming principles (e.g., inheritance, polymorphism, and encapsulation).

A second representation of the data structure 20 is illustrated as an XML schema 34 that defines a structure of an XML document 38 having various elements 40. The XML schema 34 may define an XML type 36 that defines various properties and constraints of various elements of the XML type 36, such as the number and types of fields associated therewith. An XML document 38 may be generated that conforms to the XML schema 34, and that includes a representation of the data structure 20 as an element formatted according to the XML type 36 defined in the XML schema 38. In particular, the XML document 38 contains a hierarchically organized set of elements 40 that are respectively identified by a start tag enclosed in angle brackets, begin with the name of the element 40, and may feature one or more attributes. An element 40 may be closed by a closing tag (denoted by angle brackets containing a forward slash and the name of the element 40 being closed) or may be self-closing (e.g., including a forward slash at the end of the start tag). Values may be inserted into this XML document 38, e.g., as attributes included within an element 40 (denoted as a name/value pair, such as “myAttribute=“MyValue”); as a value, such as a string or a number, stored between the start tag and the end tag; and/or as an encapsulated data structure of the same or another type. For example, in the exemplary scenario 10 of FIG. 1, the XML document 38 defines a definition 48 of the data structure 20 identified as “MyClass,” having a start tag (e.g., “<MyClass>”) and an end tag (e.g., “</MyClass>”) and featuring various elements 40 representing various fields of the data structure 20 (e.g., a “<dateCreated>” element 20 having the value “12/31/2010” and an “<iSize>” element 20 having the value “128”), each of which stores a value 22 in a similar manner as the object 30 and the data structure 20.

A third representation of the data structure 20 is illustrated as a record 56 in a relation 52 of a relational database 50. The relational database 50 may define a set of relations 52, each having a set of attributes 54 specifying various fields and the constraints thereof, and a set of records 56 that include values for each of the attributes 54 of the relation 52 that satisfy the constraints thereof. The relation 52 is often presented as a table having various columns (corresponding to attributes 54) and a set of one or more rows (corresponding to records 56) that have a value for each column. The relational database 50 illustrated in the exemplary scenario 10 of FIG. 1 includes a relation 52 entitled “MyClass Instances,” which is structured to store instances of the MyClass data structure 20, such as a first record 56 having value 22 for an dateCreated attribute 54 of “12/31/2010” and a value 22 for an iSize attribute 54 of “128.” In this manner, the various representations of the data structure 20 may feature a similar set of data represented in different ways, where each representation may have particular uses or advantages in particular contexts within the computing environment.

The structure of the data structure 20 is defined in a similar manner in each of these representations. Moreover, the data structure 20 represented in a first representation may be translated into a second representation through the use of automated techniques. For example, the relation 52 of the relational database 50 may be expressed as an XML document 38, or may be imported from an XML document 38; an object 30 comprising an instance of a class 28 may be automatically stored in a corresponding relation 52 of a relational database 50, or may be extracted therefrom; and an object 30 may be serialized into an XML document 38, or may be generated (e.g., deserialized) from the XML document 38 according to the structure specified in the XML schema 34. In this manner, an application configured to perform a particular task may translate the data structure 20 into a representation that is advantageous for the task.

Despite these similarities among the representations, there are significant differences in the expressive power of each representation. In particular, an XML document 38 may contain a significant amount of information that is not defined by the XML schema 34, since, as a document that may be written and read by individuals in addition to being automatically processed, the XML document 38 may be formatted to promote readability, such as by inserting comments and whitespace. The XML document 38 may also include preprocessing instructions that do not relate to the data of represented data structures 20, but that rather provide references and instructions for parsing the XML document 38 (such as references to related namespaces and to the XML specification hosted by the World Wide Web Consortium (W3C)). While many of these “non-schematized” aspects (e.g., information that is not represented according to the XML schema 34 of the XML document 38) may be relevant only to the human reader, some aspects might contain significant information that is relevant to the represented data.

In the exemplary scenario 10 of FIG. 1, several elements of the XML document 38 are presented that do not relate to the XML schema 34. As a first example, the XML document 38 contains a preprocessor directive 42 that specifies the XML specification version according to which the XML document 38 is defined and the character formatting. As a second example, several forms of whitespace are included in the XML document 38, such as extra line feeds that separate parts of the XML document 38 and tabs that denote hierarchy. As a third example, a developer comment 46 is included that describes a portion of the XML document 38. In addition to the content of the non-schematized elements, the location may also be significant; e.g., a developer comment 46 may be positioned at many locations within the XML document 38, and the location may represent the schematized elements 40 of the XML document 38 to which the developer comment refers 46. These non-schematized aspects are permitted and valid according to the XML specification, but are not addressed by the XML schema 34. Accordingly, automated processing techniques that generate one or more objects 30 from an XML document 38 based on an XML schema 34 often cannot include the non-schematized elements in the representation. This omitted information may cause complications; e.g., without this information, it is not possible to regenerate the original XML document 38 using only the contents of the object 30, and any XML document 38 generated from a data structure 20 represented as an object 30 may lack fidelity with the original representation of the data structure 20 in the original XML document 38.

A second example (not illustrated in the exemplary scenario 10 of FIG. 1) involves updates to the XML schema 34 that may no longer relate to some elements of an XML document 38 based on an earlier version of the XML schema 34. While these elements 40 may be automatically processed in a naïve manner (e.g., if the XML schema 34 is unavailable), a translation of an object 30 from the data structure 20 of the XML document 38 according to the updated XML schema 34 may omit these elements 40 due to the omission of valid information in the XML schema 34 about the elements 40. A third example (also not illustrated in the exemplary scenario 10 of FIG. 1) relates to the authoring of an XML schema 34 by a developer for a particular task, which may involve only parts of the data structures 20 represented therein. The developer may (intentionally or unintentionally) fail to specify in the XML schema 34 the elements 40 that are not involved in the task contemplated by the developer. While this XML schema 34 and the associated XML documents 38 are both valid, the elements 40 in the data structures 20 that are not defined by the XML schema 3 are disregarded as non-schematized elements 40 by many automated parsing of the XML document 38 into objects 30.

Presented herein are techniques for generating representations of a data structure 20 in various automated ways that promote the fidelity of the data structure 20 with its original representation, regardless of translations into different representations. In particular, a data structure 20 represented in an XML document 38 may be translated into an object 30 for use in an object system according to the structural specifications of the XML schema 34 upon which the XML document 38 is formatted. For example, the data structure 20 specified in the XML document 38 may include many elements 40 (e.g., “schematized” elements) specifying various fields 14 that may be translated into class members 32 and associated values 22 of the object 30. However, the XML document 38 may also include many non-schematized aspects, such as whitespace, developer comments, preprocessor directives, and elements 40 of the XML document 38 that are simply undefined by the XML schema 34. According to the techniques presented herein, these non-schematized aspects may be included in the object 30 in a “delta,” which specifies both the content of the non-schematized information and the location within the XML document 38. This information may be referenced by an application or developer interacting with the object 30, and may be used to generate an XML document 38 having full fidelity with the original XML document 38 from which the object 30 was extracted.

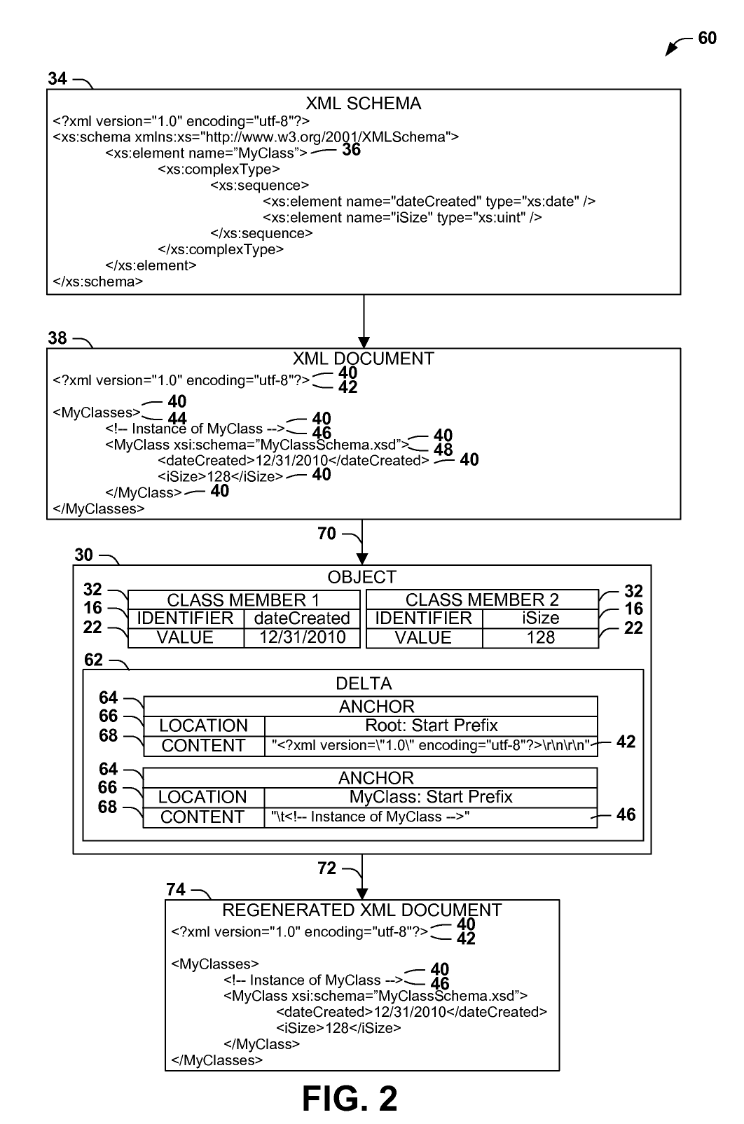

FIG. 2 presents an exemplary scenario 60 featuring automated translations between representations of a data structure 20 that, according to the techniques presented herein, preserve the full fidelity of the original representation. In this exemplary scenario 60, an XML schema 34 defines an XML type 36, and an XML document 38 formatted according to the corresponding XML document 38 includes (within the root element 44 of the XML document 38) elements 40 that define an instance of the XML type 36 as a data structure 20 named “MyClass.” The XML document 38 also includes several non-schematized aspects, such as a preprocessor directive 42, whitespace, and a developer comment 46. A first automated translation 70 of the XML document 38 may result in an object 30 having various class members 32 with identifiers 16 and values 22 corresponding to the elements 40 of the XML document 38 (and where such values 22 conform to the specification of the XML schema 34). However, the first automated translation 70 also includes in the object 30 a delta 62 that represents non-schematized aspects of the XML document 38. This delta 62 comprises a set of anchors 64, each defining a location 66 and content 68 of a non-schematized aspect, such as a first anchor 64 representing the preprocessor directive 42 and a second anchor 64 representing the developer comment 46. An application or developer examining the object 30 may therefore reference the delta 62 to identify and utilize the non-schematized aspects of the XML document 38, even if the XML document 38 is unavailable. Additionally, a second automated translation 72 may be applied to the object 30 to generate a regenerated XML document 74. By utilizing both the information in the class members 32 and in the delta 62 of the object 30, the second automated translation 72 may translate the object 30 into a regenerated XML document 74 having full fidelity with the XML document 38 wherein the representation of the object 30 originated.

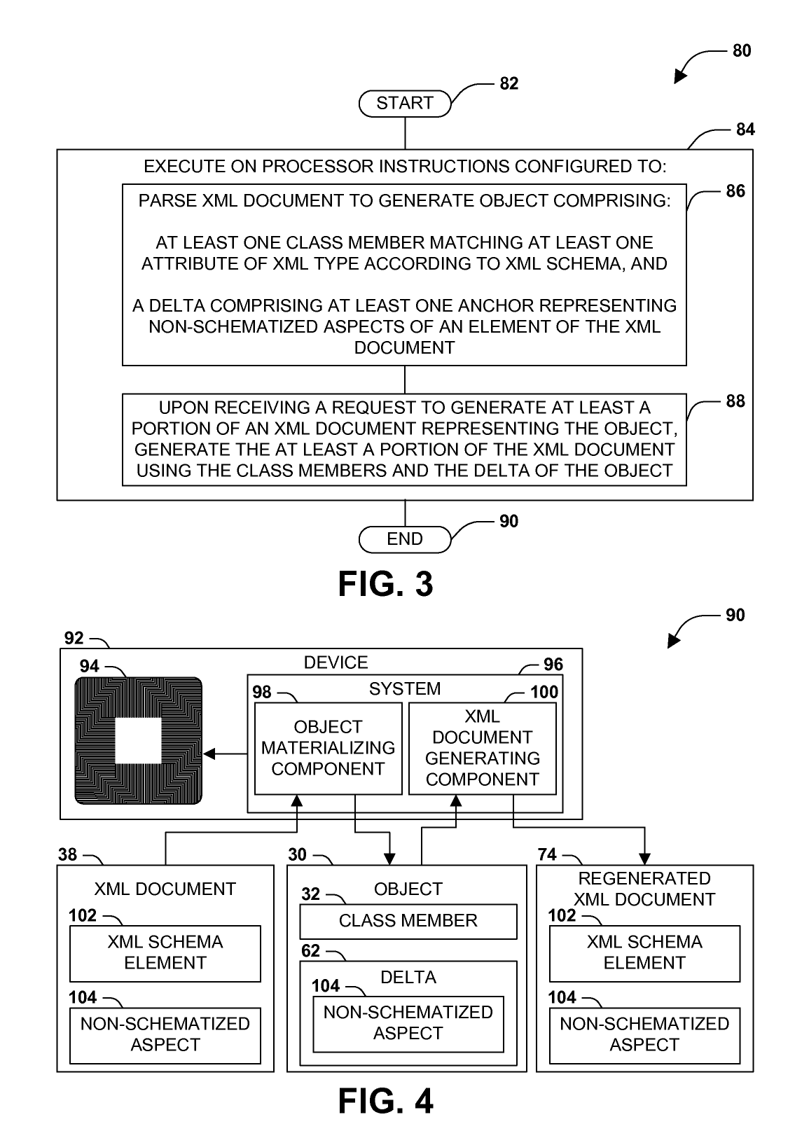

FIG. 3 presents a first embodiment of these techniques, illustrated as an exemplary method 80 of presenting a data structure 20 formatted as an XML type 36 and stored in an XML document 38 formatted according to an XML schema 34. The exemplary method 80 may be implemented, e.g., as a set of software instructions stored in a memory component (such as system memory, a hard disk drive, a solid state storage device, or a magnetic or optical disc) of a device having a processor. The exemplary method 80 begins at 82 and involves executing 84 on the processor instructions configured to perform the techniques presented herein. In particular, the instructions are configured to parse 86 the XML document 38 to generate an object 30 comprising at least one class member 32 matching at least one attribute of the XML type 36 according to the XML schema 34, and a delta 62 comprising at least one anchor 64 representing non-schematized aspects of an element 40 of the XML document 38. The instructions may also be configured to, upon receiving a request to generate at least a portion of an XML document 38 representing the object 30, generate 88 the at least a portion of the XML document 38 using the class members 32 and the delta 62 of the object 30. Having achieved a representation of the data structure 20 as an object 30 including the non-schematized aspects of the initial representation, whereupon a regenerated XML document 74 may be generated having full fidelity with the original representation in the XML document 38, the exemplary method 80 ends at 90.

FIG. 4 presents a second embodiment of these techniques, illustrated as an exemplary system 96 operating in a device 92 having a processor 94 and configured to present a data structure 20 formatted as an XML type 36 and stored in an XML document 38 formatted according to an XML schema 34. The exemplary system 96 may be implemented, e.g., as a software architecture comprising a set of components, each comprising instructions stored in a memory of the device 92 that, when executed on the processor 94, interoperate with the other components to achieve the techniques presented herein. The exemplary system 96 may also be invoked in the context of an XML document 38 comprising a set of XML schema elements 102 (e.g., elements 40 having definitions in the XML schema 34) and a set of non-schematized aspects 104 (e.g., whitespace, preprocessor directives 42, developer comments 46, and elements 40 that are not defined or that are not valid according to the XML schema 34).The exemplary system 96 comprises an object materializing component 98, which is configured to parse the XML document 38 to generate an object 30 comprising at least one class member 32 matching at least one attribute of the XML type 36 according to the XML schema 34, and a delta 62 comprising at least one anchor 64 representing non-schematized aspects of an element 40 of the XML document 38. The exemplary system 96 also comprises an XML document generating component 100, which is configured to, upon receiving a request to generate at least a portion of an XML document 34 representing the object 30, generate the at least a portion of the XML document 34 (e.g., as a regenerated XML document 74) using the class members 32 and the delta 62 of the object 30. In this manner, the exemplary system 96 preserves both the XML schema elements 102 and the non-schematized aspects 104 of the XML document 38 for use by applications and for a full-fidelity regeneration of the XML document 38.

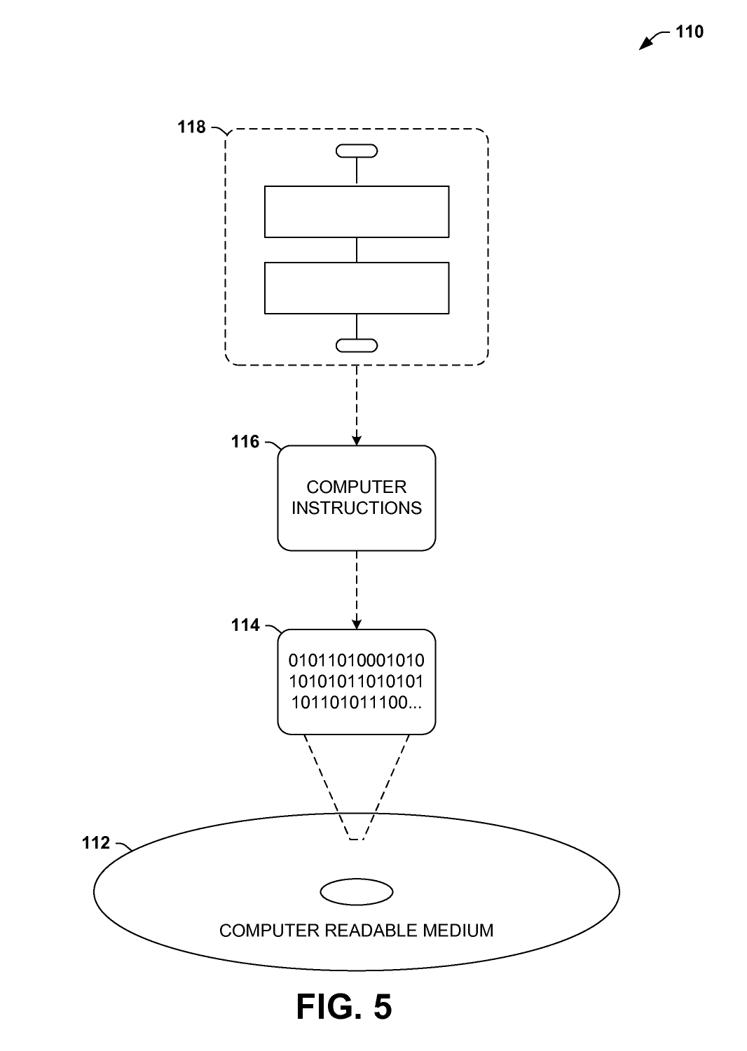

Still another embodiment involves a computer-readable medium comprising processor-executable instructions configured to apply the techniques presented herein. An exemplary computer-readable medium that may be devised in these ways is illustrated in FIG. 5, wherein the implementation 110 comprises a computer-readable medium 112 (e.g., a CD-R, DVD-R, or a platter of a hard disk drive), on which is encoded computer-readable data 114. This computer-readable data 114 in turn comprises a set of computer instructions 116 configured to operate according to the principles set forth herein. In one such embodiment, the processor-executable instructions 116 may be configured to perform a method of presenting a data structure formatted as an XML type and stored in an XML document formatted according to a schema, such as the exemplary method 80 of FIG. 3. In another such embodiment, the processor-executable instructions 116 may be configured to implement a system for presenting a data structure formatted as an XML type and stored in an XML document formatted according to a schema, such as the exemplary system 96 of FIG. 4. Some embodiments of this computer-readable medium may comprise a non-transitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 80 of FIG. 3 and the exemplary system 96 of FIG. 4) to confer individual and/or synergistic advantages upon such embodiments.

A first aspect that may vary among embodiments of these techniques relates to the manner of generating the object 30 from the XML document 38. As a first example, an embodiment of these techniques may, upon receiving a request to generate one or more objects 30 from an XML document 38, evaluate the XML schema 34 associated with the XML document 38, may extract into class members 32 the XML schema elements 102 of the data structures 20 represented in the XML document 38, and may generate the delta 62 comprising the non-schematized aspects 104 of the XML document 38. This evaluation of the XML schema 34 and the XML document 38 may be advantageous, e.g., for promoting the flexibility of the embodiment in evaluating newly presented XML documents 38 in an ad hoc manner. Alternatively, an embodiment may pre-evaluate the XML schema 34 to identify how any XML document 38 formatted based on the XML schema 34 may be parsed into objects 30, and, upon receiving a request to parse objects 30 from an XML schema 34, may use the results of the pre-evaluation to generate objects 30. This pre-evaluation of the XML schema 34 may be advantageous, e.g., for promoting the performance of the embodiment in evaluating XML documents 38 formatted according to previously available XML schemata 34.

As a second example of this first aspect, the evaluation of an XML schema 34 may result in many types of information and representations thereof to promote the parsing of XML documents 38 formatted according to such XML schemata 34. As one variation, the evaluation of an XML schema 34 may result in the generation of one or more mappings, each of which identifies an association of an element 40 of an XML schema 34 to class members 32 of objects 30. Accordingly, an embodiment may generate, based on the XML schema 34, at least one mapping of an element 40 of the XML document 38 to a class member 32 of the object 30, and may later parse the XML document 38 to generate one or more objects 30 by, for respective elements 40 of the XML document 38, identifying a mapping that matches the element 40, and adding a class member 32 to the object 30 according to the mapping. As a further variation, the embodiment may, based on the XML schema 34, generate an object builder, such as a function or automaton that includes a set of mappings generated based on the XML schema 34. The object builder may then be invoked with an XML document 38, and may generate one or more objects 30 respectively representing a data structure 20 stored in the XML document 38 formatted according to the XML schema 34.

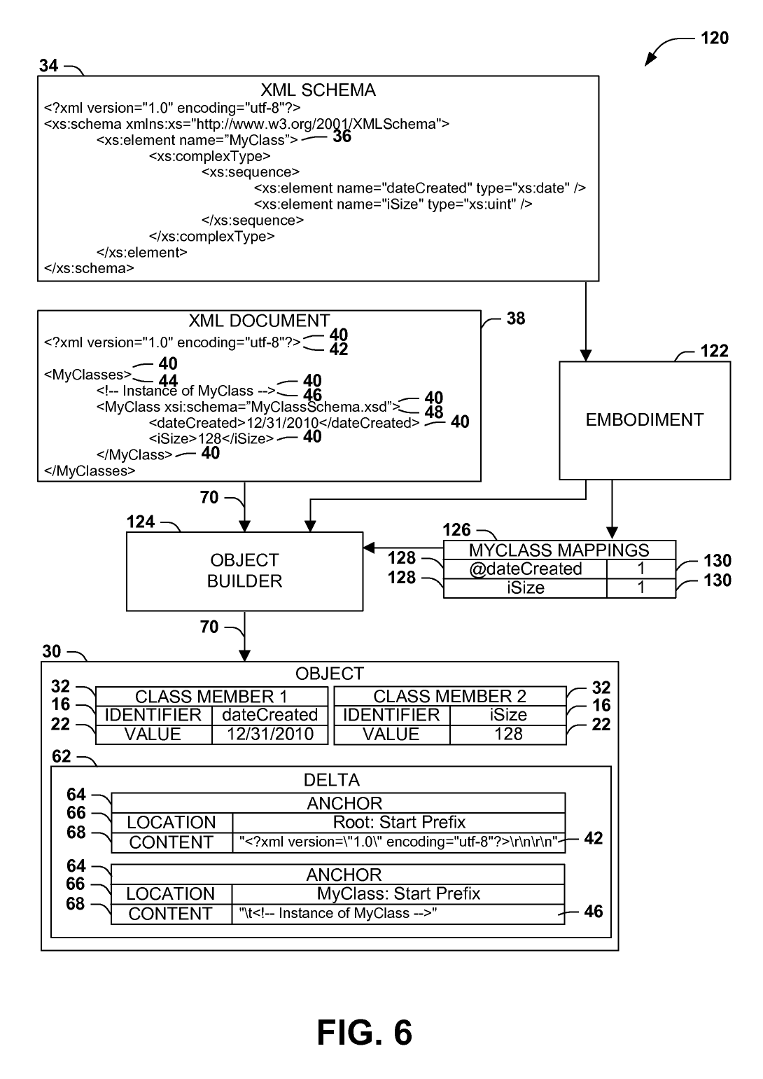

FIG. 6 presents an illustration of an exemplary scenario 120 featuring a generation of one or more objects 30 based on an XML document 38 formatted according to an XML schema 34. An embodiment 122 of these techniques may, at a first time point, evaluate the XML schema 34 to identify one or more mappings 126 that associate elements 40 of XML documents 38 formatted according to the XML schema 34 with class members 32 of class members 30 that may be generated therefrom. For example, a mapping 126 may include an identifier 128 (such as a name) and one or more type identifiers 130 that indicate a shared formatting of elements 40 of data structures 20 in the XML document 38 and associated class members 32. The embodiment 122 may also generate an object builder 124, such as an automaton that may be invoked with an XML document 38 formatted according to the XML schema 34, and may, based on the mappings 126, generate one or more objects 30 therefrom. At a second time point, after the object builder 124 and the mappings 126 have been generated, a request may be received to parse an XML document 38 and to generate one or more objects 30, and may perform the first automated translation 70 by invoking the object builder 124 with the XML document 38 to generate the objects 30 using the mappings 126. In this manner, the output builder 124 may be utilized to improve the performance of the embodiment 122 in processing the XML document 38 to generate objects 30 therefrom.

As an additional variation of this second example, while parsing an XML document 38, an embodiment of these techniques may encounter a particular element 40 and may choose a mapping 126 that identifies a first class 28 defining the object 30 associated with the mapping 126 and the class member 32 to be added to the object 30. However, an element 40 of the data structure 20 may specify an XML type 36, such as with an “xsi:type” attribute, that is associated with a second class 28. The embodiment may then have to choose between the first class 28 and the second class 28 as the type for the object 30, and may, upon detecting the XML type 36, generate the object 30 according to the XML type 36 specified in the element 40 rather than the XML type 36 selected according to the mapping 126. However, since this declaration may be included as an attribute of an element 40 for which processing has already begun (and possibly after other elements), the embodiment may have to discard the object 30 for which generation had initially begun (according to the first class 28) and restart the parsing of the object 30 according to the second class 28.

As a third example of this first aspect, an embodiment of these techniques may, while parsing the XML document 38 and generating objects 30 therefrom, also validate the XML document 38. Many current techniques based on XML parsing are configured to compare the XML document 38 with the XML schema 34 in order to determine whether the XML document 38 fulfills the conditions of the XML schema 34 as a precursor to parsing the XML document 38 in order to generate objects 30. However, conducting two passes on the XML document 38 may be inefficient (particularly in scenarios where the processing of XML documents 38 and the generation of objects 30 is a rate-limiting technique within a larger process). Therefore, it may be more efficient to validate the XML document 38 in the same pass as parsing the XML document 38 to generate objects 30. For example, the instructions may be configured to, while parsing the XML document 38, identify various types of schema violations of the XML schema 34 associated with the XML document 38, and to generate a validation result indicating whether or not the XML document 38 fulfills the XML schema 34. In particular, the instructions may be configured to distinguish fatal XML schema violations from non-fatal XML schema violations. For example, when an embodiment may be configured to, upon detecting an XML schema violation that comprises an absence of non-optional information, such that the generation of objects 30 cannot continue, raise an XML schema validation exception; and upon completing the parsing of the XML document 38 without raising an XML schema validation exception, raise an XML schema validation event that indicates to any interested processes that the XML document 38 is valid. For violations of the XML schema 34 that do not comprise an absence of non-optional information, the embodiment may be configured to handle these cases as non-fatal XML schema violations, and to store such information in the delta 62. The embodiment may also raise an exception to indicate these non-fatal XML schema violations, but may continue processing the XML document 38. This type of relaxed validation of the XML document 38 may be advantageous, e.g., in promoting the robustness of the XML parsing, such that when an XML schema 34 upon which existing XML documents 38 are formatted is changed, an embodiment may nevertheless continue to generate objects 62 in the absence of non-fatal XML schema violations. Those of ordinary skill in the art may devise many ways of generating objects 30 based on XML documents 38 in accordance with the techniques presented herein.

A second aspect that may vary among embodiments of these techniques relates to the nature of the delta 62 and the anchors 64 included therein to represent the non-schematized aspects 104 of the XML document 38. As a first example, an anchor 64 may indicate the location of a non-schematized aspect 104 within the XML document 83 in many ways. In one such variation, an anchor 62 may represent a non-schematized aspect 104 relative to one or more one or more XML schema elements 102, e.g., according to an identifier and a position. The identifier may indicate an XML schema element 102 according to a path, such as an XPath designation or a Component Designer expression. However, a path may be insufficient to identify the particular XML schema element 102 to which the location of the non-schematized aspect 104 relates, because the XML specification and many XML schemas 34 permit the specification of a sequence of identical elements 40. Accordingly, a fully and unambiguously specified location of a non-schematized element may include a specification of the position of the referenced element 40 within the list. Including the position may be significant in achieving full fidelity, e.g., if a non-schematized aspect 104 is located between two identical XML schema elements 102 in the XML document 38. Non-schematized aspects 104 of an XML document 30 may be stored in an anchor 64 in various ways, such as a string comprising the extracted XML fragment or a collection of objects (such as a first object representing a whitespace string and a second object representing a non-schematized element 40 within the XML document 38).

As a third example of this second aspect, an anchor 64 in the delta 62 may comprise a region collection, where each region comprises non-schematized aspects 104 within a particular area in relation to the identified XML schema element 102. For example, in relation to an XML schema element 102, a non-schematized aspect 104 may exist in several areas. For example, a start prefix region may include any non-schematized aspects 104 located before an opening tag of the XML schema element 102, and an end prefix region may include any non-schematized aspects 104 located before a closing tag of the XML schema element 102. A start content region may include any non-schematized aspects 104 located within the opening tag of the XML schema element 102, and an end content region may include any non-schematized aspects 104 located within the closing tag of the XML schema element 102 (if the XML schema element 102 is not self-closing). Additionally, an element content region may, for an atomic element 40, include any non-schematized aspects 104 located inside the atomic element, e.g., between the opening tag and the closing tag of the atomic element 40. (If the element 40 is not atomic, then other elements 40 are nested between the opening tag and the closing tag of element 40, and the location of the non-schematized aspects 104 may be specified in relation to these nested elements 40.) Additionally, an anchor 64 may include a self-closing indicator that indicates whether an element 40 targeted by the anchor 64 self-closes (e.g., having an “<element/>” format) or does not self-close (e.g., having an “<element></element>” tag pair), and this information may have to be preserved in order to achieve a full-fidelity regeneration of the XML document 38.

As an additional variation of this third example, additional anchors 64 in the delta 62 of an object 30 may be included to represent non-schematized aspects 104 having locations that are difficult to specify relative to an XML schema element 102. For example, a root anchor may be included to represent non-schematized aspects 104 located relative to a root element 44 of the XML document 38, such as preprocessor directives 42 positioned at the beginning of the XML document 38; and a null anchor may be included to represent non-schematized aspects 104 located at the end of the XML document 38.

As a fifth example of this second aspect, the selection of XML schema elements 102 for which one or more anchors 64 are specified may vary in several ways. In one such variation, an anchor 64 may be generated and stored in the delta 62 for any XML schema element 102 relative to which a non-schematized aspect 104 is located. This variation may be advantageous, e.g., for reducing the number of anchors 64 stored in the delta 62, which may be inefficient if comparatively few non-schematized aspects 104 are included in the XML document 38 (e.g., if the location of a non-schematized aspect 104 may be specified relative to several XML schema elements 102, it may be more efficient to select an XML schema element 102 corresponding to an anchor 64 already existing in the delta 62 than to generate a new anchor 64 corresponding to a different XML schema element 102). Alternatively, each XML schema element 102 in the XML document 38 may correspond to an anchor 64 in the delta 62. This variation may be more efficient, e.g., for automatically generating the anchors 64, particularly if a significant number of non-schematized aspects 104 exist in the XML document 38. As an additional advantage of this variation, the anchors 64 of the delta 62 may also represent the order of the XML schema elements 102 stored in the XML document 38. This information may have to be preserved in order to achieve a full-fidelity regeneration of the original XML document 38. Accordingly, a request to regenerate the XML document 38 may be fulfilled by representing the XML schema elements 102 within the regenerated XML document 74 according to the order of the anchors 64 stored within the delta 62.

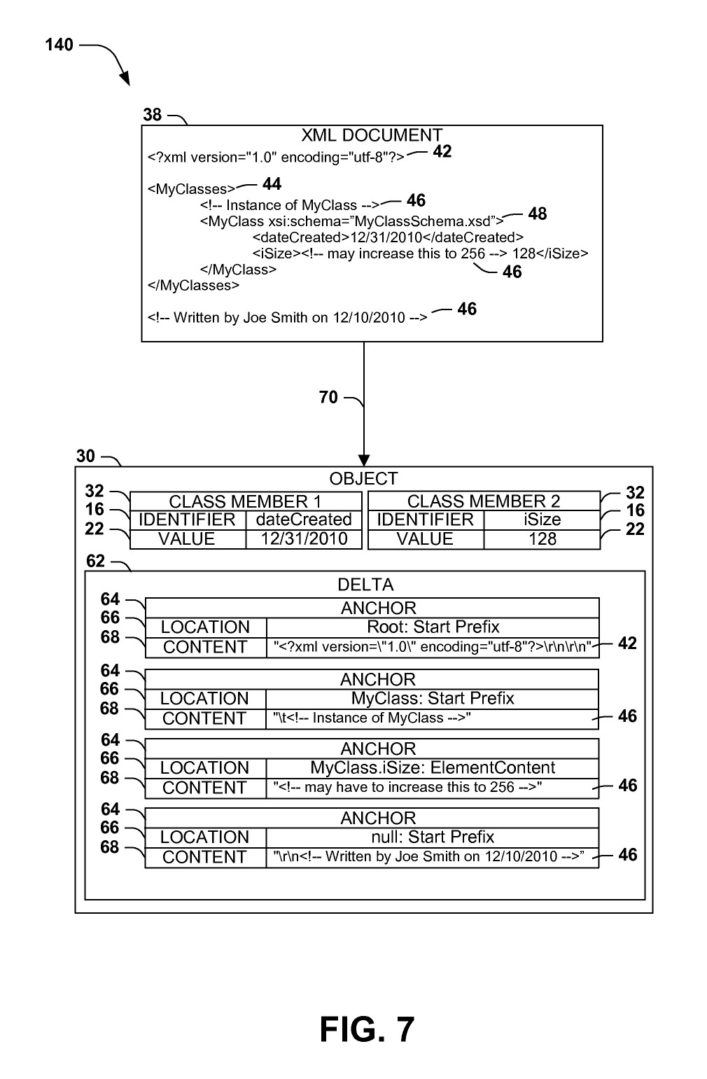

FIG. 7 presents an illustration of an exemplary scenario 140 featuring a first automated translation 70 of an object 30 from an XML document 38, such that the object 30 includes a delta 62 having various anchors 64. The XML document 38 may include, in addition to many XML schema elements 102 having definitions specified in an XML schema 34 associated with the XML document 38, various non-schematized aspects 104, such as a preprocessor directive 42, whitespace, and one or more developer comments 46. Accordingly, the object 30 may include various class members 32 corresponding to the XML schema elements 102 in the XML document 38, but may also include several anchors 64 within the delta 62 to represent these non-schematized aspects 104. For example, a first anchor 64 may represent the preprocessor directive 42 with a location 66 corresponding to the root element 44 of the XML document 38, and within a start prefix region of this anchor 64. A second anchor 64 may be included to represent a first developer comment 46 stored in the start prefix region of the XML schema element 102 representing the root of the MyClass data structure 20, and a third anchor 64 may be included to represent a developer comment 46 stored within the element content region of the iSize field 14 of the data structure 20. Finally, a fourth anchor 64 may be included to represent a developer comment 46 stored within the start prefix region of a null anchor (e.g., after all of the schematized XML elements 102 of the XML document 38). In this manner, many of the non-schematized aspects of the XML document 38 may be represented (and other anchors 64, not shown, may be included to specify whitespace included for visual formatting of the XML document 38). Additionally, the order of the anchors 64 within the delta 62 may correspond to the order of the non-schematized aspects 104 within the XML document 3. Those of ordinary skill in the art may devise many ways of representing the delta 62 for the non-schematized aspects 104 of the XML document 38 while implementing the techniques presented herein.

A third aspect that may vary among embodiments of these techniques relates to updates to an object 30 generated from an XML document 38. In some scenarios, the object 30 may be read-only (and may not permit updates), while in other scenarios, the object 30 may be updated but may remain independent of the XML document 38 from which the object 30 was generated. However, in other scenarios, updates to the object 30 may be (automatically or upon request) propagated back to the source XML document 38. Accordingly, an embodiment of these techniques may be configured to, upon generating an object 30, store a reference to the XML document 38 from which the object 30 was generated, such as a file stored in a filesystem or a record stored in a relational database, and upon receiving an update of at least one class member 32 of the object 30, update at least one element 40 of the XML document 38 associated with the at last one class member 32 in order to reflect the update.

As a first example of this third aspect, the update may specify at least one simple class member that may be comparatively easy to update in the XML document 38. For example, the update may relate to a change to a simple data type, such as an integer or a string, and the relevant portion of the XML document 38 may be rewritten. In particular, the embodiment may include various XML-writing operators that may perform various selective updates on an XML document 38, such as an XML insert operator that may insert one or more XML elements 40 into an XML document 38, an XML update operator that may change one or more XML elements 40 in an XML document 38, and an XML delete operator that may remove one or more XML elements 40 from an XML document 38. The embodiment may therefore invoke one or more XML-writing operators to alter the XML document 38 to reflect the update. This example may be advantageous, e.g., where the XML document may be stored as several representations (such as a file, a stream, an object representation of the XML document 38, or a record in a relational database), and where the particular representation format is not relevant to the update to the object 30, and parallel XML-writing operators may be included in the XML-writing operator set to target different representations of the XML document 38. For example, the XML insert operator set may include a first operator that inserts XML elements 40 into an XML file, a second operator that inserts XML elements 40 into an object representation of the XML document 38, and a third operator that inserts records 56 into a relation 52 of a relational database 50. In particular, a relational database 50 may include at least one database-specific operator that may be associated with a placeholder XML-writing operator, and the elements 40 of an XML document 38 stored in the relational database 50 may be updated by sending to the relational database 50 at least one relational query configured to reflect the update that specifies at least one placeholder XML-writing operator associated by the relational database 50 with a database-specific operator. This form of updating may be achieved, e.g., by automatically adding or supplementing one or more object member setters of class members 32 comprising simple data types included in the object 30 to update the XML document 38 from which the object 30 was generated.

As an additional variation of this first example of this third aspect, an update of an object 30 may affect at least one anchor 64. For example, if a class member 32 of an object 30 is removed from the object 30, it may be desirable to remove from an anchor 64 a developer comment 46 included in the XML document 38 in relation to the removed class member 32. Accordingly, an embodiment of these techniques may be configured to, upon detecting an update of an object 30 that may affect one or more anchors 64, update the anchors 64 of the delta 62 based on the update.

As a second example of this third aspect, some updates to an object 30 may significantly affect the content or structure of the object 30 in a manner that discourages a simple alteration of the XML document 38 from which the object 30 was generated, such as an update of at least one non-simple class member (e.g., a reordering or expansion of a hashtable). In these scenarios, it may be more efficient to update the representation of the object 30 in the XML document 38 by regenerating the XML document 38, using the class members 32 and the delta 62 of the object 30. In one such embodiment, when an embodiment of these techniques may be configured to, while parsing an XML document 38, generate an XML document writer (such as an output automaton) that is configured to generate at least a portion of an XML document 38 representing one or more objects 30, using both the class members 32 and the delta 62 of the object 30 to generate an XML document 38 having full fidelity with the original XML document 38. Accordingly, an update to the object 30 may involve invoking the XML document writer to generate the XML document 38. The XML document writer may generate either a portion of the XML document 38 including the object 30 (such as an XML fragment, or a well-formatted XML document that includes only the object 30)or a set of objects 30 related to the object 30, or may regenerate the entire XML document 38. Additionally, the XML document writer may be invoked promptly upon detecting the update to the object 30, may be invoked periodically (e.g., in a cached manner), or may await a request from a user to propagate changes to the object 30 back to the XML documents 38. In this manner, updates to the object 30 may be propagated back to the XML document 38 from which the object 30 was generated. Those of ordinary skill in the art may devise many ways of updating objects 30 generated from XML documents 38 while implementing the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

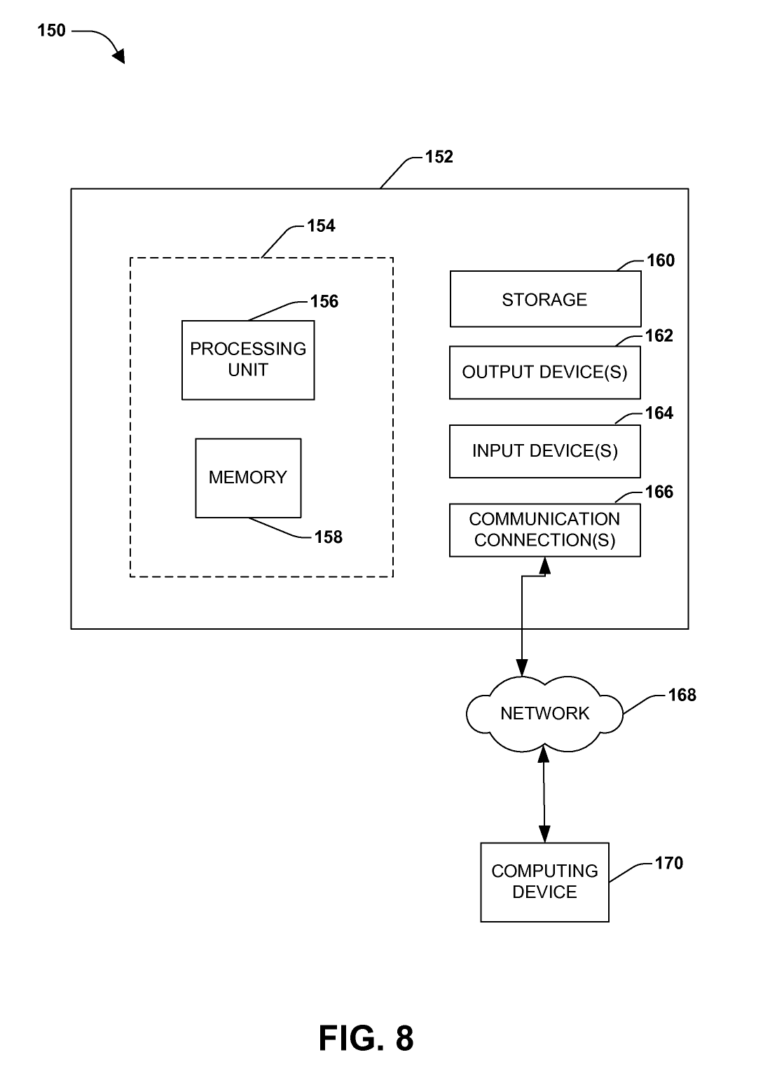

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 150 comprising a computing device 152 configured to implement one or more embodiments provided herein. In one configuration, computing device 152 includes at least one processing unit 156 and memory 158. Depending on the exact configuration and type of computing device, memory 158 may be volatile (such as RAM, for example), non-volatile (such as ROM, flash memory, etc., for example) or some combination of the two. This configuration is illustrated in FIG. 8 by dashed line 154.

In other embodiments, device 152 may include additional features and/or functionality. For example, device 152 may also include additional storage (e.g., removable and/or non-removable) including, but not limited to, magnetic storage, optical storage, and the like. Such additional storage is illustrated in FIG. 8 by storage 160. In one embodiment, computer readable instructions to implement one or more embodiments provided herein may be in storage 160. Storage 160 may also store other computer readable instructions to implement an operating system, an application program, and the like. Computer readable instructions may be loaded in memory 158 for execution by processing unit 156, for example.

The term “computer readable media” as used herein includes computer storage media. Computer storage media includes volatile and nonvolatile, removable and non-removable media implemented in any method or technology for storage of information such as computer readable instructions or other data. Memory 158 and storage 160 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 152. Any such computer storage media may be part of device 152.

Device 152 may also include communication connection(s) 166 that allows device 152 to communicate with other devices. Communication connection(s) 166 may include, but is not limited to, a modem, a Network Interface Card (NIC), an integrated network interface, a radio frequency transmitter/receiver, an infrared port, a USB connection, or other interfaces for connecting computing device 152 to other computing devices. Communication connection(s) 166 may include a wired connection or a wireless connection. Communication connection(s) 166 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 152 may include input device(s) 164 such as keyboard, mouse, pen, voice input device, touch input device, infrared cameras, video input devices, and/or any other input device. Output device(s) 162 such as one or more displays, speakers, printers, and/or any other output device may also be included in device 152. Input device(s) 164 and output device(s) 162 may be connected to device 152 via a wired connection, wireless connection, or any combination thereof. In one embodiment, an input device or an output device from another computing device may be used as input device(s) 164 or output device(s) 162 for computing device 152.

Components of computing device 152 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 152 may be interconnected by a network. For example, memory 158 may be comprised of multiple physical memory units located in different physical locations interconnected by a network.

Those skilled in the art will realize that storage devices utilized to store computer readable instructions may be distributed across a network. For example, a computing device 170 accessible via network 168 may store computer readable instructions to implement one or more embodiments provided herein. Computing device 152 may access computing device 170 and download a part or all of the computer readable instructions for execution. Alternatively, computing device 152 may download pieces of the computer readable instructions, as needed, or some instructions may be executed at computing device 152 and some at computing device 170.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting a data structure formatted as an XML type and stored in an XML document formatted according to an XML schema on a device having a processor, the method comprising:
executing on the processor instructions configured to:
parse the XML document to generate an object comprising:
at least one class member matching at least one attribute of the XML type according to the XML schema, and
a delta comprising at least one anchor representing non-schematized aspects of an element of the XML document; and
upon receiving a request to generate at least a portion of an XML document representing the object, generate the at least a portion of the XML document using the class members and the delta of the object.

2. The method of claim 1:
the instructions configured to generate, based on the XML schema, at least one mapping of an XML document element to a class member of the object; and
parsing the XML document to generate the object comprising:
for respective elements of the XML document, identifying a mapping that matches the element; and
adding a class member to the object according to the mapping.

3. The method of claim 2:
the instructions configured to generate, based on the XML schema, an object builder configured to, using the mappings, generate objects respectively representing a data structure stored in an XML document formatted according to the XML schema; and
generating the object comprising: invoking the object builder with the XML document to generate the object representing the data structure stored in the XML document.

4. The method of claim 1:
the data structure specifying an XML type; and
the instructions configured to, upon detecting the XML type specified by the data structure, generate the object according to the XML type.

5. The method of claim 1, the instructions configured to:
upon identifying in the XML document an XML schema violation of the XML schema comprising an absence of non-optional information, raise an XML schema validation exception; and
after parsing the XML document without raising an XML schema validation exception, raise an XML schema validation event.

6. The method of claim 5, the instructions configured to, upon identifying in the XML document an XML schema violation of the XML schema not comprising an absence of non-optional information, represent the XML schema violation in the delta of the object.

7. The method of claim 1, respective anchors identifying the element of the XML document according to an identifier and a position.

8. The method of claim 1, respective anchors representing the non-schematized aspects of an element of the XML document as a region collection comprising:
a start prefix region comprising non-schematized aspects represented before an opening tag of the element;
a start content region comprising non-schematized aspects represented within the opening tag of the element;
an element content region comprising, for an atomic element, non-schematized aspects represented inside the atomic element;
an end content region comprising non-schematized aspects represented within a closing tag of the element; and
an end prefix region comprising non-schematized aspects represented before the closing tag of the element.

9. The method of claim 1, respective anchors comprising a self-closing indicator that indicates whether the element self-closes.

10. The method of claim 1, the delta comprising:
a root anchor representing non-schematized aspects of the root element of the XML document, and
a null anchor representing non-schematized aspects following the root element of the XML document.

11. The method of claim 1, the delta storing the anchors in an order corresponding to an order of the elements in the XML document.

12. The method of claim 1, each element in the XML document corresponding to an anchor in the delta.

13. The method of claim 1, the instructions configured to, upon receiving an update of a class member of the object, update at least one element of the data structure in the XML document associated with the class member to reflect the update.

14. The method of claim 13:
the update specifying at least one simple class member; and
updating the at least one element of the data structure in the XML document comprising: invoking on the XML document at least one XML-writing operator to reflect the update, the at least one XML-writing operator selected from an XML-writing operator set comprising:
an XML insert operator;
an XML update operator; and
an XML delete operator.

15. The method of claim 14:
the XML document stored in a relational database specifying at least one database-specific operator associated with a placeholder XML-writing operator; and
invoking the at least one XML-writing operator on the XML document comprising: sending to the relational database at least one relational query configured to reflect the update and specifying at least one placeholder XML-writing operator associated by the relational database with a database-specific operator.

16. The method of claim 13:
the update affecting at least one anchor; and
updating the at least one element of the data structure in the XML document comprising: updating at least one anchor based on the update.

17. The method of claim 13:
the update specifying at least one non-simple class member; and
updating the at least one element of the data structure in the XML document comprising: regenerating the XML document using the class members and the delta of the object.

18. The method of claim 17:
the instructions configured to generate, based on the XML schema, an XML document writer configured to generate at least a portion of an XML document representing the object; and
regenerating the XML document comprising: invoking the XML document writer with the at least one object.

19. A system configured to present a data structure formatted as an XML type and stored in an XML document formatted according to an XML schema, the system comprising:
an object materializing component configured to parse the XML document to generate an object comprising:
at least one class member matching at least one attribute of the XML type according to the XML schema, and
a delta comprising at least one anchor representing non-schematized aspects of an element of the XML document; and
an XML document generating component configured to, upon receiving a request to generate at least a portion of an XML document representing the object, generate the at least a portion of the XML document using the class members and the delta of the object.

20. A computer-readable storage medium comprising instructions that, when executed by a processor of a device, present a data structure formatted as an XML type and stored in an XML document formatted according to an XML schema by:
generating, based on the XML schema, at least one mapping of an XML document element to a class member of the object;
generating, based on the XML schema, an object builder configured to, using the mappings, generate objects respectively representing a data structure stored in an XML document formatted according to the XML schema;
generating, based on the XML schema, an XML document writer configured to generate at least a portion of an XML document representing the object;
invoking the object builder with the XML document to parse the XML document to generate an object comprising:
at least one class member matching at least one attribute of the XML type according to the XML schema, and
a delta comprising at least one anchor stored in an order corresponding to an order of the elements in the XML document, respective anchors comprising an identifier and a position that together represent a non-schematized aspect of an element of the XML document, the position selected from a region collection comprising:
a start prefix region comprising non-schematized aspects represented before an opening tag of the element;
a start content region comprising non-schematized aspects represented within the opening tag of the element;
an element content region comprising, for an atomic element, non-schematized aspects represented inside the atomic element;
an end content region comprising non-schematized aspects represented within the closing tag of the element;
an end prefix region comprising non-schematized aspects represented before the closing tag of the element; and
a self-closing indicator that indicates whether the element self-closes; by:
for respective elements of the XML document, identifying a mapping that matches the element;
adding a class member to the object according to the mapping;
adding to the delta of the object a root anchor representing non-schematized aspects of the root element of the XML document;
adding to the delta of the object a null anchor representing non-schematized aspects following the root element of the XML document;
upon identifying in the XML document an XML schema violation of the XML schema comprising an absence of non-optional information, raising an XML schema validation exception;
upon identifying in the XML document an XML schema violation of the XML schema not comprising an absence of non-optional information, representing the XML schema violation in the delta of the object; and
after parsing the XML document without raising an XML schema validation exception, raising an XML schema validation event;
upon receiving a request to generate at least a portion of an XML document representing the object, generating the at least a portion of the XML document using the class members and the delta of the object;
upon receiving an update of a class member of the object specifying at least one simple class member:
invoking on the XML document at least one XML-writing operator to reflect the update, the at least one XML-writing operator selected from an XML-writing operator set comprising:
an XML insert operator;
an XML update operator; and
an XML delete operator; and
updating at least one anchor based on the update; and
upon receiving an update of a class member of the object specifying at least one non-simple class member, regenerating the XML document using the class members and the delta of the object by invoking the XML document writer with the at least one object.
